(19) United States
(12) Patent Application Publication
(10) Pub. No.: US 2009/0308528 A1
(43) Pub. Date: Dec. 17, 2009

(54) Multilayered Bamboo Article

(76) Inventor: Tom Sullivan, San Marcos, CA (US)

Correspondence Address: ERIC HANSCOM, 7395 PORTAGE WAY, CARLSBAD, CA, 92011, US

(21) Appl. No.: 12/548,395

(22) Filed: Aug. 26, 2009

Related U.S. Application Data
(63) Continuation-in-part of application No. 11/751,542, filed on May 21, 2007.
(60) Provisional application No. 60/802,224, filed on May 19, 2006.

(51) Int. Cl. B32B 38/04; B32B 37/00

(52) U.S. Cl. 156/256; 156/60

(57) ABSTRACT

A multilayered bamboo article and a method for making the same is disclosed. Strips of bamboo with roughly square cross sections are secured together into layers in which the layer has parallel grain orientations. These layers are then combined together in perpendicular grain orientations to form a multilayered bamboo article. The bamboo strips and layers are secured together using a glue resistant to high temperatures when cured resulting in a strong multilayered bamboo article resistant to the effects of hot water.

### CROSS REFERENCE TO RELATED APPLICATIONS

This patent application is a continuation-in-part of pending U.S. patent application Ser. No. 11/751,542 filed on May 21, 2007, which in turn is a non-provisional of now expired U.S. Provisional Patent Application Ser. No. 60/802,224 filed on May 19, 2006, the entireties of which are hereby incorporated by reference.

### STATEMENT REGARDING FEDERALLY SPONSORED RESEARCH OR DEVELOPMENT

This invention was not federally sponsored

### BACKGROUND OF THE INVENTION

### FIELD OF THE INVENTION

This invention relates to the general field of bamboo articles, and more specifically toward a multilayered bamboo article and a method for making the same. Strips of bamboo with roughly square cross sections are secured together into layers in which the layer has parallel grain orientations. These layers are then combined together in perpendicular grain orientations to form a multilayered bamboo article. The bamboo strips and layers are secured together using a glue resistant to high temperatures when cured resulting in a strong multilayered bamboo article resistant to the effects of hot water.

Bamboo, a type of grass, is growing in popularity throughout the world in various applications. Its fast rate of growth makes it a plentiful and inexpensive renewable resource. Bamboo is now being used in various industries including construction, kitchen wares, furniture, cabinetry (including countertops), culinary arts, medicine, and even clothing.

Unlike trees, a bamboo stem will typically reach its full height in one growing season. As the fastest growing woody plants in the world, bamboo can grow up to 24 inches in one day. This results in a source of strong wood that is easily replenished after being harvested. When harvesting, bamboo stems that are between one and five years old are usually selected. Stems younger than one year are not fully woody and thus are not as strong. Stems older than five years start to decay and thus are also not as strong.

There are three types of bamboo grain: vertical grain, flat grain, and end grain. Vertical grain, approximately ¼″ wide, is taken from the side of a split pole of bamboo; flat grain, approximately ⅝″ wide, is from the face of the pole; and end grain is the cross section of the pole. End grain is the pattern observed in a piece of bamboo when it is viewed from a surface displaying the ends of the bamboo's fiber. Vertical grain, also known as long grain, is the pattern observed in a piece of bamboo when it is viewed from a surface displaying the sides of the bamboo's fiber. Direction is commonly associated with vertical grain patterns, and the grain is said to run in the direction of the bamboo's fibers, and will thus be referenced in that manner. For a stalk of bamboo, end grain is visible on the ends of the stalk, and vertical grain runs along the length of the stalk and is visible on the side surfaces of the stalk. The grain on the face of the bamboo pole is known as the face grain or flat grain. The vertical grain is the portion of the stalk corresponding to the thickness, or the narrower dimension of the stalk.

Bamboo strips are created from stalks of bamboo. The stalk is split apart and then cut into strips having a rectangular cross section. As with other types of wood, bamboo will absorb water that will cause it to swell. This wicking action can pull adjacent water into a bamboo strip thereby causing it to swell. However, due to the three-dimensional nature of the grains and internal structure of bamboo, the bamboo strip does not increase in size equally in all three dimensions. In fact, bamboo strips with rectangular cross sections that swell due to absorbed moisture encounter a cupping effect, whereby the sides of the cross section bend inward or outward. The cupping effect reduces the applications in which adjacent strips of bamboo can be used.

Prior art applications of bamboo strips, such as in bamboo cutting boards, counter tops, and the like, use parallel placed rectangular strips of bamboo glued together. The glue used in these applications is commonly a non-formaldehyde glue that loses its cured adhesive properties when heated to relatively low temperatures. This results in a device that is not resistant to water or high temperatures. In applications such as cutting boards, the result is a clearly inferior product compared to cutting boards using other materials. After repeated rinsing, the bamboo strips of a prior art bamboo cutting board will show signs of cupping. This leads to cracks and warping of the cutting board. Placing a prior art bamboo cutting board in a dishwasher has also led to failure. The increased temperatures degrade the glue used to bind the strips of bamboo together resulting in cracking and even total failure of the cutting board. The hot water used in a dishwasher will also accelerate the cupping of each bamboo strip. Similar results will be found in other articles made of rectangular cross-section bamboo strips subject to heat and/or water, including counter tops, utensils, and tableware.

Thus there has existed a long-felt need for a multilayered bamboo article that is resistant to the effects of water and high temperatures. Cracking and warping should be avoided to enable the use of the bamboo article in or around water. Preferably, the glue used to bind the bamboo article together can resist high temperatures such that the article can be used in a dishwasher. For multilayered bamboo articles such as cutting boards and countertops, the surface of the bamboo article should be strong and resilient. It should withstand repeated bombardments by knifes and other kitchen tools without substantial degradation. Further, the bamboo article should be aesthetically pleasing.

### SUMMARY OF THE INVENTION

The current invention provides just such a solution by having a multilayered bamboo article and a method for making the same. Strips of bamboo with roughly square cross sections are secured together into layers in which the layer has parallel grain orientations. These layers are then combined together in perpendicular grain orientations to form a multilayered bamboo article. The bamboo strips and layers are secured together using a glue resistant to high temperatures when cured resulting in a strong multilayered bamboo article resistant to the effects of hot water.

Prior art bamboo articles that use parallel rectangular strips are highly susceptible to cracking and warping. When introduced to water, especially warm or hot water, the cross section of rectangular bamboo strips will cup and the length of the bamboo strips may warp thereby leading to cracking and other deformities of the bamboo article. Bamboo strips with roughly square cross sections are thus beneficial. When the bamboo strip absorbs moisture, it expands by roughly the same amount in each direction of the cross-sectional area thereby resulting in little to no cupping. Explained in further detail below, the process for creating the roughly square cross section of the bamboo square isn't as efficient as the prior art methods for creating rectangular strips. However, the square cross section of the bamboo strip leads to a far superior product that has increased value that compensates for the inefficiencies in the process. It is resistant to the effects of swelling that results in a multilayered bamboo article that lasts a significantly longer period of time compared to the prior art.

The glue used in the current invention to bind the strips of bamboo together is Prefere 166 C. It's components include 40-60% synthetic co-polymer emulsion, 1-10% poly-vinyl alcohol, 20-35% filler, 10-20% water, and less than 1% surfactant. One of the key properties of this glue is that after curing, it retains its adhesive qualities even when heated to temperatures of 120° C. This non-formaldehyde glue allows the multilayered bamboo article to be washed in a standard dishwasher without deforming. This is a significant convenience factor for many consumers. Further, washing an article in a dishwasher has been found to use less water than doing a comparable wash by hand. Therefore, such a dishwasher safe bamboo article reduces water consumption compared to non-dishwasher safe articles.

Vertical grain layers provide a unique look that is aesthetically pleasing. The current invention's layers of bamboo show these vertical grains on the external surface of the article. Additionally, vertical grains are a strong and durable surface that is appropriate for use as a cutting board or counter top.

It is a principal object of the invention to provide a bamboo article that resists cracking and warping when exposed to moisture.

It is another object of the invention to provide a bamboo article that retains its shape and qualities when subject to high temperatures.

It is a further object of the invention to provide a bamboo article that is dishwasher safe.

It is an additional object of the invention to provide a bamboo article that is strong and durable such that it can be used as a cutting surface.

It is a final object of this invention to provide a bamboo article that is aesthetically pleasing and functional.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE FIGURES

The accompanying drawings, which are incorporated in and form a part of this specification, illustrate embodiments of the invention and together with the description, serve to explain the principals of this invention.

FIG. 1 is a side perspective view of a cutting board embodiment of the multilayered bamboo article according to the current invention.

FIG. 2 is side view of the cutting board.

FIG. 3 is a top view of the cutting board.

FIG. 4 shows the steps of obtaining a rectangular bamboo strip form a bamboo stalk.

FIG. 5 shows the steps of obtaining a sheet of square bamboo strips from a plank of rectangular bamboo strips.

### DETAILED DESCRIPTION OF THE INVENTION

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings.

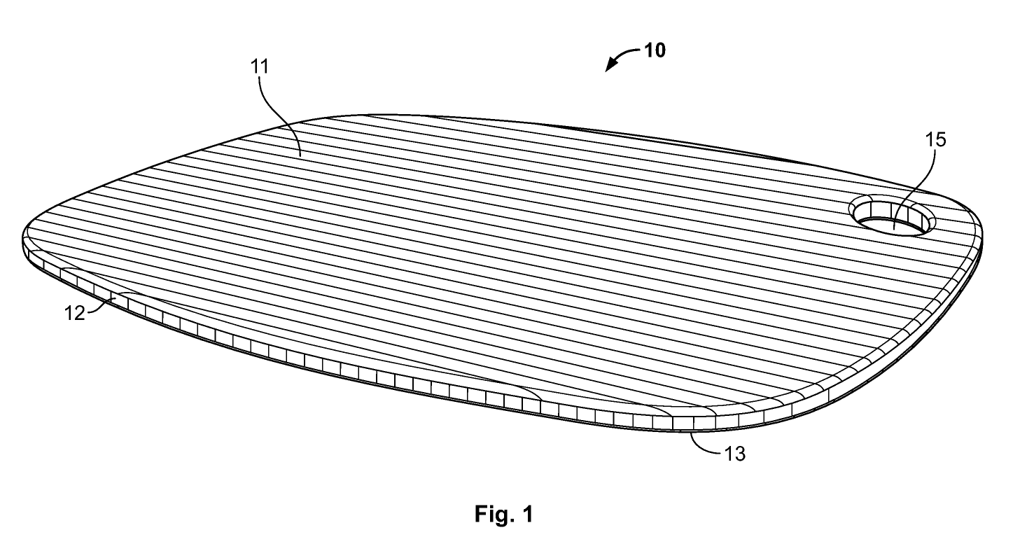

FIG. 1 is a side perspective view of a cutting board embodiment of the multilayered bamboo article according to the current invention. A cutting board 10 is shown that includes three layers. Each layer is made up of parallel bamboo strips that are roughly square in cross section. This layer is more clearly shown and described in FIG. 5 below. The first layer 11 is shown on top, whereby they lines show individual parallel bamboo strips. The third layer 13 is on the bottom and, though difficult to see in this figure, has parallel bamboo strips that are oriented in the same direction as the first layer. The second layer 12 is between the first layer 11 and the third layer 13. It also has parallel bamboo strips, but this layer has a perpendicular orientation to the first layer 11 and third layer 13. The cutting board 10 is shown with rounded sides and a cutout hole 15 that enables a user to more easily grasp the cutting board.

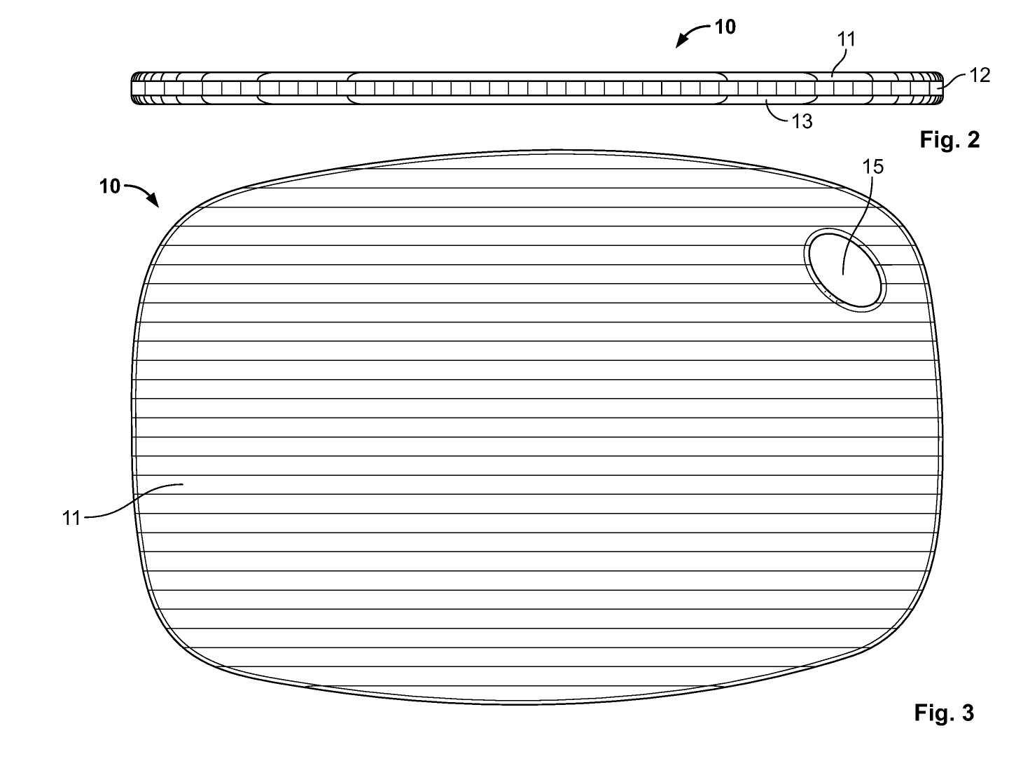

FIG. 2 is side view of the cutting board. The cutting board 10 has a first layer 11 and a third layer 13 that are on the top and bottom, respectively. The second layer 12 is in the middle of and in a perpendicular orientation to the first and third layers.

FIG. 3 is a top view of the cutting board. The top layer 11 is shown with its parallel bamboo strips. A cutout hole 15 enables a user to more easily grasp the cutting board.

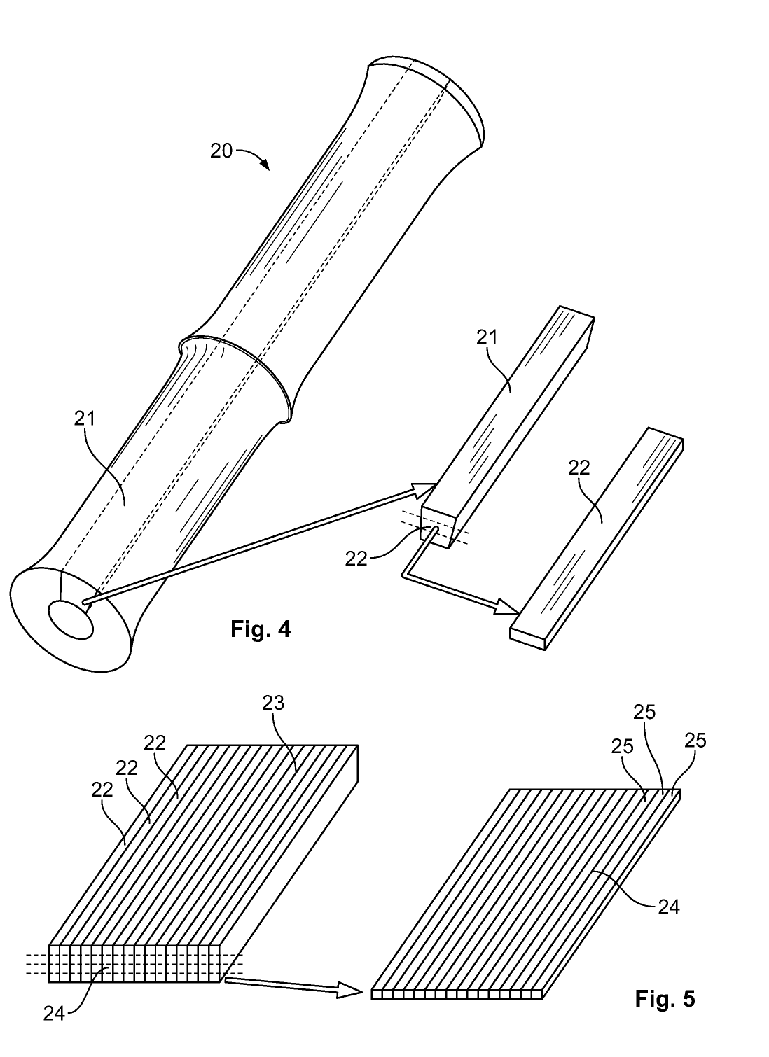

FIG. 4 shows the steps of obtaining a rectangular bamboo strip form a bamboo stalk. First, an appropriate bamboo stalk 20 is selected. A 10 to 12-foot long portion is selected from the bottom of the bamboo stalk where the bamboo is strongest. From this, a roughly 1-inch by 1-inch cross-section is cut from the bamboo stalk 20 resulting in a cutout strip 21. This cutout strip 21 is roughly square in shape, though slightly trapezoidal, and preferably 10 to 12-feet long. Then, the face and inside portion of the cutout strip 21 is removed leaving a rectangular strip 22 that is ¼-inches by 1-inch (or, in some cases, ¾-inches due to manufacturing tolerances) by 10-feet. This step is repeated for each cutout strip 21 created from the bamboo stalk 20, as well as with additional bamboo stalks, to create a large number of rectangular strips.

The resulting rectangular strips must be prepared for further processing. Each rectangular strip 22 is kiln dried. After this, the rectangular strip 22 can be colored if desired. The rectangular strip 22 should also be stabilized by allowing the rectangular strip 22 to rest for 3 weeks. If the bamboo rectangular strip 22 is going to warp, it will do so in this 3-week period and can be rejected and discarded at this time. Whether or not colored, the rectangular strips may come in a variety of colors. The different colored rectangular strips can be matched together or randomized throughout resulting in uniform, patterned, or randomly colored bamboo articles.

FIG. 5 shows the steps of obtaining a sheet of roughly square bamboo strips from a plank of rectangular bamboo strips. Whether color matched or not, a large number of rectangular strips 22 are glued together to form a bamboo plank 23. The rectangular strips 22 are glued together face to face; the 1-inch side of the rectangular strip 22 is glued to a 1-inch side of another rectangular strip 22. The resulting bamboo plank 23 is roughly the size of a sheet of plywood, with a cross-sectional size of 4 feet by 1-inches. End grains and face grains are at the edges of the bamboo plank 23, with the vertical grain showing on the top and bottom of the bamboo plank 23. The bamboo plank 23 is then cut into four equal parts (or three if the resulting bamboo plank has a thickness of ¾ inches). Each of these four equal parts is a bamboo sheet 24. Each bamboo sheet contains square strips 25 oriented in the same direction, with each square strip 25 having a square ¼-inch by ¼-inch cross section. The bamboo sheet itself, therefore, has a thickness of ¼-inches.

The bamboo sheets are then used to create the multilayered bamboo article. For the cutting board shown in FIGS. 1 through 3, three bamboo sheets are used. The bamboo sheets are cut and glued together (or alternatively, glued together and then cut) to form the desired shape, in this instance, a cutting board. Prefere 166 C glue is used. One of the key properties of this glue is that after curing, it retains its adhesive qualities even when heated to temperatures of 120° C. This allows the multilayered bamboo article to be washed in a standard dishwasher without deforming. However, when the glue is being cured, such as under hot pressing, the temperature must be kept below 85° C. Heat pressing is a preferable when gluing the bamboo sheets together. After the sheets are glued together, any finishing sanding can be performed to render a smooth surface around the entire multilayered bamboo article, if desired. Optionally, the sanding can be done before gluing. For added strength and durability, each bamboo sheet is oriented in a perpendicular direction to the adjacent sheet.

The resulting multilayered bamboo article is strong, durable, dishwasher safe, and resistant to high temperature water. The top and bottom of the multilayered bamboo article shows a vertical grain, both a durable and aesthetically pleasing side. Because of the above arrangements, there is little to now cupping in the square cross sections of each square strip, and little to not warping and cracking in the overall multilayered bamboo article.

Throughout this document, including the claims, shapes and sizes are meant to be approximations. For example, square should be interpreted as roughly square and ¼-inches as roughly ¼-inches to allow for slight variations in dimensional sizes and manufacturing tolerances.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A method for making a multilayered bamboo article comprising the steps of:
cutting a bamboo stalk into cutout strips;
removing the face and inside portions of the strips thereby producing rectangular strips, where the rectangular strips have rectangular cross-sections;
drying the rectangular strips;
resting the rectangular strips;
gluing the rectangular strips together to form a bamboo plank;
cutting the bamboo plank into equal parts thereby forming bamboo sheets; and
gluing two or more bamboo sheets together to form a multilayered bamboo article.

2. The method of claim 1, wherein the cutout strips are square.

3. The method of claim 1, wherein the cutout strips have a cross section of 1-inch by 1-inch.

4. The method of claim 1, wherein the cutout strips are between 10 and 12-feet long.

5. The method of claim 1, wherein the rectangular strips have a cross section ¾-inches by ¼-inches.

6. The method of claim 1, wherein the rectangular strips rest for at least 3 weeks.

7. The method of claim 1, wherein the rectangular strips have a height and a width, where the width is greater than the height, and wherein the bamboo plank is formed by gluing the widths of the rectangular strips together.

8. The method of claim 7, wherein the bamboo planks have a thickness of 1-inch.

9. The method of claim 1, wherein the bamboo sheets have a thickness of ¼ inches.

10. The method of claim 1, wherein the bamboo sheets are comprised of square bamboo strips with square cross-sections.

11. The method of claim 10, wherein the square bamboo strips have a cross section of ¼-inches by ¼-inches.

12. The method of claim 10, wherein each bamboo sheet of the multilayered article is oriented in a perpendicular direction to its adjacent bamboo sheet.

13. A method for making a multilayered bamboo article comprising the steps of
obtaining two or more bamboo sheets, where each bamboo sheet consists of parallel bamboo strips secured together; where each bamboo strip has a cross section and a length;
combining the two or more bamboo sheets together such that the length of the bamboo strips of one sheet are perpendicular to the bamboo strips of an adjacent sheet.

14. The method of claim 13, wherein the bamboo strips have a square cross section.

15. The method of claim 14, wherein the bamboo strips have a cross section of ¼-inches by ¼-inches.

16. The method of claim 13, wherein the parallel bamboo strips are secured together by glue.

17. The method of claim 13, wherein the two or more bamboo sheets are combined by gluing and heat pressing the bamboo sheets together.

18. A method for making a multilayered bamboo article comprising the steps of:
cutting a bamboo stalk into cutout strips;
removing the face and inside portions of the cutout strips thereby producing rectangular strips, where the rectangular strips have a rectangular cross-section, where the rectangular strips have a thickness of ¼-inches;
gluing the rectangular strips together to form a bamboo plank;
cutting the bamboo plank into equal parts thereby forming bamboo sheets; where the bamboo sheets comprises square bamboo strips, where each square bamboo strip has a length and a cross-section of ¼-inches by ¼-inches, gluing two or more bamboo sheets together to form a multilayered bamboo article, where the length of the square bamboo strips of each sheet are perpendicular to the lengths of the square bamboo strips of an adjacent sheet.

19. The method of claim 18, wherein the cutout strips have a cross-section of 1-inch by 1-inch.

20. The method of claim 18, wherein the glue used to glue the two or more bamboo sheets together can resist temperatures of at least 120° C. once cured.
